(19) United States
(12) Patent Application Publication
(10) Pub. No.: US 2026/0175382 A1
(43) Pub. Date: Jun. 25, 2026

(54) DRIVING TOOL

(71) Applicant: MAKITA CORPORATION, Anjo-shi (JP)

(72) Inventors: Makito TERAMOTO, Anjo-shi (JP); Kiyonobu YOSHIKANE, Anjo-shi (JP)

(73) Assignee: MAKITA CORPORATION, Anjo-shi (JP)

(21) Appl. No.: 19/364,629

(22) Filed: Oct. 21, 2025

(30) Foreign Application Priority Data
Dec. 24, 2024 (JP) 2024-227167

(51) Int. Cl. B25C 1/00; B25C 1/06

(52) U.S. Cl. CPC B25C 1/005; B25C 1/06

(57) ABSTRACT

A driving tool has a tool main body and a magazine. The magazine is secured to the tool main body by a locking member. An actuator allows for quick magazine detachment from the tool main body by moving the locking member from a locking position to an unlocking position. The actuator is operable in an operating direction that intersects a feed direction of a driving member in the magazine and a driving direction of the driving member. The magazine can be detached from the tool main body by rotating the magazine in a removal direction while unlocking the actuator with one hand.

### CROSS-REFERENCE TO RELATED APPLICATION

This application claims priority to Japanese patent application serial number 2024-227167, filed on Dec. 24, 2024, the contents of which are incorporated herein by reference in their entirety for all purposes.

### TECHNICAL FIELD

The present invention generally relates to a driving tool equipped with a magazine capable of loading a plurality of driving members (fasteners), such as nails or staples, for use in fastening operations.

### BACKGROUND

A driving tool for driving nails into, for example, concrete, is configured such that a magazine loaded with driving members (fasteners) can be detached from a tool main body of the driving tool in order to remove a driving member when the driving member is stuck in a nose section. A driving tool is well known in which a magazine is configured to be attached by engaging an end portion of the magazine in a feed direction with a nose portion of a tool main body of the driving tool and then engaging a rear portion of an operation member of the magazine with the tool main body. The magazine is removable from the tool main body by moving the operation member to an unlock side and moving the rear portion of the magazine in a disengaging direction.

For another example, a driving tool is also well known in which a magazine is configured to slidably engages a slide base that protrudes from a nose portion of the tool in a lateral direction. The magazine can be attached by engaging an operation member on a rear side of the slide base with a lock portion on a rear side of the magazine. The magazine can be detached by moving the operation member to an unlock side in order to disengage from the lock portion and sliding the magazine in a removal direction.

### SUMMARY

In the above described driving tools, when removing the magazine, a user is required to move the operation member along an extension direction of the magazine, or along on a surface including a feed direction of the driving members (fasteners), with one hand, and then move the magazine in a removal direction with another hand. For this reason, in the conventional driving tools, it is necessary, for example, to place the driving tool on a workbench in order to perform the magazine removal operation with both hands free. In this respect, the removal operation is troublesome. Thus, there is a need to improve operability for removing the magazine of the driving tool.

Current disclosures relate to a driving tool that has a tool main body for driving a driving member and a magazine provided detachably on the tool main body for supplying the driving member (fastener) to the tool main body. The driving tool has a locking member provided in the magazine for attaching the magazine to the tool main body. The driving tool has an operating portion (actuator) provided in the magazine and operated when removing the magazine from the tool main body to move the locking member from a locking position to an unlocking position. The actuator is operable in an operating direction intersecting both the feed direction of the driving member in the magazine and the driving direction of the driving member.

Because of this configuration, by operating the actuator in the operating direction, the locking member is moved from the locking position to the unlocking position, thereby removing the magazine from the tool main body. This improves the operability for magazine detachment.

The operating direction of the actuator is in a direction intersecting both the feed direction of the magazine of the driving member and the driving direction of the driving member. Accordingly, the operating direction is generally in the left-right direction as viewed from the user who holds the driving tool. For this reason, the user can hold the grip of the driving tool with a right hand, for example, and the magazine with a left hand while operating the actuator to move the magazine forward to detach it from the tool main body. In this way, the magazine can be detached from the tool main body while being held in the hand during work, etc., without the trouble of temporarily placing the driving tool on a workbench. This improves operability of detaching the magazine from the tool main body.

### BRIEF DESCRIPTION OF DRAWINGS

FIG. 1 is a left side view of a driving tool according to an embodiment of the present disclosure.

FIG. 2 is a front view of the driving tool, which is viewed in a direction indicated by an arrow II in FIG. 1.

FIG. 3 is a top view of the driving tool, which is viewed in a direction indicated by an arrow III in FIG. 1.

FIG. 4 is a left side view of the driving tool without a left half housing, which is viewed in a direction indicated by an arrow IV in FIG. 3.

FIG. 5 is a right side view of the driving tool without a right half housing, which is viewed in a direction indicated by an arrow V in FIG. 3.

FIG. 6 is a cross-sectional view of a lift mechanism taken along line VI-VI of FIG. 1.

FIG. 7 is a perspective view of a detached magazine.

FIG. 8 is a perspective view of a driving nose and the magazine, as seen from below.

FIG. 9 is a left side view of the driving tool with the magazine detached.

FIG. 10 is a left side view of the driving tool with the magazine locked.

FIG. 11 is a cross-sectional view taken along line XI-XI of FIG. 10.

FIG. 12 is a perspective view of a lock receptacle.

FIG. 13 is a left side view of the driving tool, showing driving members (fasteners) are located in a loading area.

FIG. 14 is a longitudinal cross-sectional view of a pusher in its retracted end position.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to another aspect of the present disclosure, an elastic member is provided for biasing the locking member from the unlocking position to the locking position. By operation of the actuator, the locking member moves from the unlocking position to the locking position against a biasing force of the elastic member. Accordingly, the locking member is biased to the locking position by the biasing force of the elastic member. The actuator is unlocked against the biasing force of the elastic member.

According to another aspect of the present disclosure, the tool main body has a guide portion for guiding the magazine in the thickness direction of the magazine when the magazine is attached to the tool main body. After being guided by the guide portion, the magazine is locked in the locking position by the locking member. Accordingly, the magazine can be easily attached to the magazine.

According to another aspect of the present disclosure, the tool main body has a play suppression member that biases the magazine to suppress any gap between the magazine and the tool main body. Therefore, rattling of the magazine is prevented when it is attached to the tool main body.

According to another aspect of the present disclosure, a cover is provided to cover the play suppression member, and the cover serves as a guide portion for guiding the magazine when the magazine is attached to the tool main body. Therefore, the usefulness of the cover is improved. In addition, a number of parts can be reduced compared to a case where the function of covering the play suppression member and the function of guiding the magazine are achieved by separate members.

According to another aspect of the present disclosure, the cover encloses a portion of the tool main body surface and guides the magazine in cooperation with the portion of the tool main body surface. Accordingly, the cover that covers the play suppression member also functions as a guide portion for guiding the magazine. This makes it possible to maintain the compactness of the tool main body and avoid an increase in the number of components.

According to another aspect of the present disclosure, the play suppression member includes a compression spring for biasing the magazine both in the driving direction and in the feed direction. Accordingly, the rattling of the magazine is prevented in both the driving direction and the feed direction.

According to another aspect of the present disclosure, the driving members (fasteners) can be loaded into the magazine from a loading area opposite to the driving direction. The actuator is provided on the rear end side of the feed diction of the driving member in the magazine relative to the loading area. Accordingly, the actuator can be positioned without compromising (sacrificing) the loading area.

According to another aspect of the present disclosure, the magazine has a pusher that pushes the driving members in the feed direction. The actuator is exposed such that it can be operated when the pusher is positioned at a retracted end position in the feed direction. Accordingly, the actuator can be operated even when the pusher is positioned at the retracted end position.

According to another aspect of the present disclosure, the tool main body has a coupling shaft serving as an engaging portion that rotatably engages a first end of the magazine. The locking member protrudes from a second end opposite the first end in a tangential direction along a circumference centered on the coupling shaft. Accordingly, the locking member engages the tool main body with greater reliability, contributing a stable locking condition of the magazine.

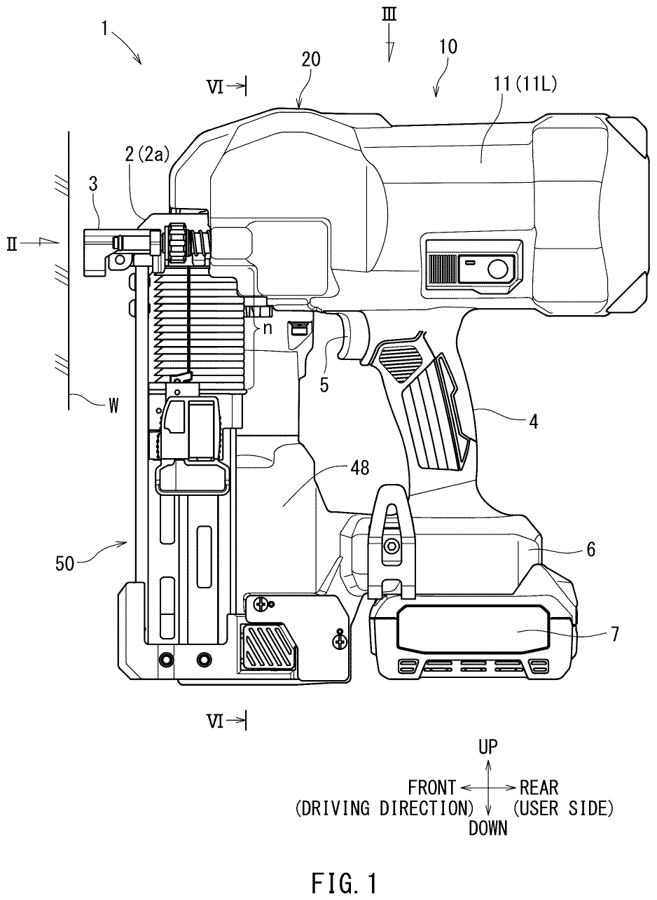

Next, an embodiment of the present disclosure will be described. In this embodiment, a gas spring type driving tool 1 is shown as a driving tool 1, which uses a gas pressure in the accumulation chamber as a thrust force for driving the driving member n. In the following description, a user holds the driving tool 1 with its front end facing forward. Therefore, the driving direction of the driving member n is a forward direction, and a direction opposite to the driving direction is a rearward direction. The user of the driving tool 1 is generally located behind the driving tool 1 (on a rear side of the driving tool 1 in FIG. 1). An up-down direction and a left-right direction are based on the user's position.

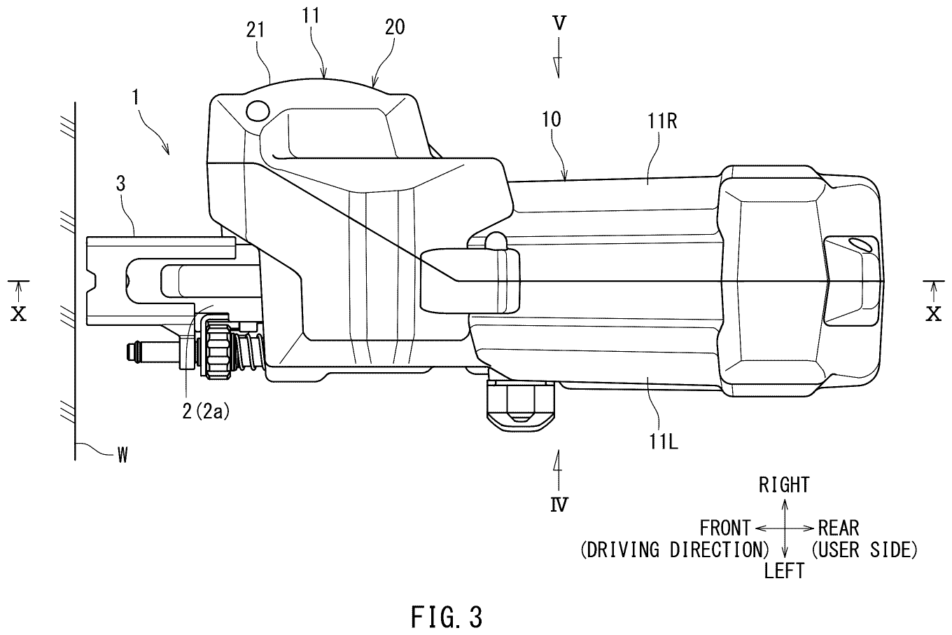

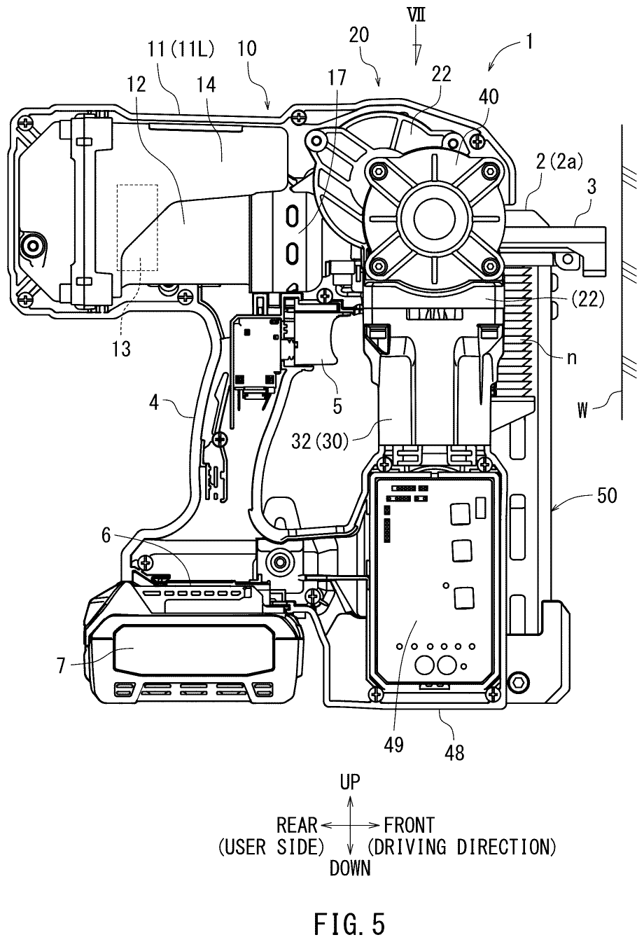

As shown in FIGS. 1 to 6, the driving tool 1 has a tool main body 10. The tool main body 10 has a tubular main body housing 11 that houses a cylinder 12. The tubular main body housing 11 has a half-split structure divided into a left half housing 11L on a left side and a right half housing 11R on a right side. The left half housing 11L and the right half housing 11R are joined together to form the main body housing 11.

A piston 13 is housed within the cylinder 12 for reciprocal motion in a front-rear direction. A rear part of the cylinder 12b behind the piston 13 is connected to (communicates with) an accumulation chamber 14. The accumulation chamber 14 is filled with a compressed gas, for example, an air. A gas pressure in the accumulation chamber 14 acts on a rear surface of the piston 13 as a thrust force for moving the piston 13 forward in the driving direction.

The front portion of the cylinder 12 is connected to a driving passage 2a of a driving nose 2 located at a front part of the tool main body 10. A magazine 50, in which a plurality of driving members n (fasteners) are loaded, is connected to the driving nose 2. For the purpose of this document, the term “driving members (fasteners) will hereinafter be referred to as “driving members”. Each driving member n is supplied from the magazine 50 to the driving passage 2a, one at a time. The driving members n are supplied in a longitudinal (front-rear) orientation. A contact arm 3 capable of relative movement in the front-rear direction is located at the front portion of the driving nose 2. The contact arm 3 contacts a workpiece W to move rearward (retreats) relative to the driving nose 2.

A driver 15 extending in the front-rear direction is coupled to the front surface of the piston 13. A front portion of the driver 15 enters the driving passage 2a. The driver 15 moves forward in the driving passage 2a owing to the gas pressure in the accumulation chamber 14 acting on the rear surface of the piston 13. A front end of the driver 15 drives a single driving member n supplied into the driving passage 2a. The driven driving member n is ejected from the ejection port 2b of the driving nose 2. The ejected driving member n is driven into the workpiece W.

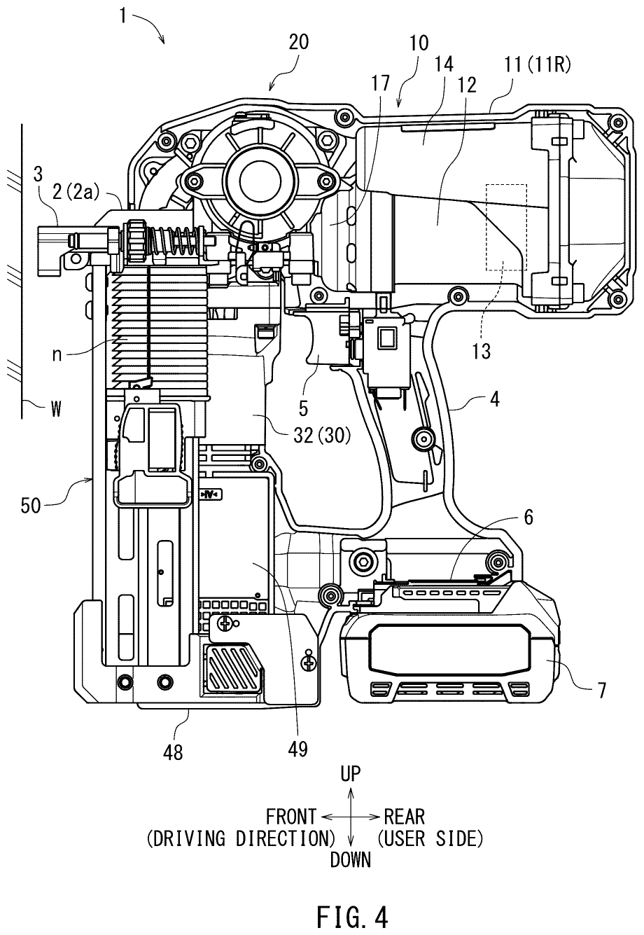

Referring to FIG. 4, a damper 17 is located on a front side of the cylinder 12 to absorb an impact of the piston 13 that reaches its forward moving end. When the driver 15 enters an inner circumference of the damper 17 and reaches the end, the driver 15 drives the driving member n (the driving operation is performed) and the piston 13 collides with the damper 17. The piston 13 stops at the forward moving end, together with the driver 15, and returns rearward to a standby position by a lift mechanism 20.

A plurality of rack teeth are provided on an upper surface of the driver 15. Each rack tooth is provided protruding upward. The driver 15 returns rearward from a forward end position in the driving direction to the standby position by sequential engagement of the plurality of rack teeth with a corresponding engagement portion on a wheel 28 of the lift mechanism 20.

As shown in FIG. 1, a grip 4 for a user to hold is located approximately in the middle of the tool main body 10 in the front-rear direction. A trigger 5, which is pull-operated by the user with his or her fingertip, is located on an upper front surface of the grip 4. When the contact arm 3 is pressed against the workpiece W and moves rearward relative to the driving nose 2, a pull operation of the trigger 5 becomes effective. A battery attachment portion 6 is located on a lower side of the grip 4. A battery pack 7 can be removably attached to a lower surface of the battery attachment portion 6. The battery pack 7 can be removed from the battery attachment portion 6 by sliding the battery pack 7 rearward relative to the battery attachment portion 6. The battery pack 7 removed from the battery attachment portion 6 can be recharged by a dedicated charger for repeated use. Power of the battery pack 7 is supplied to the lift mechanism 20.

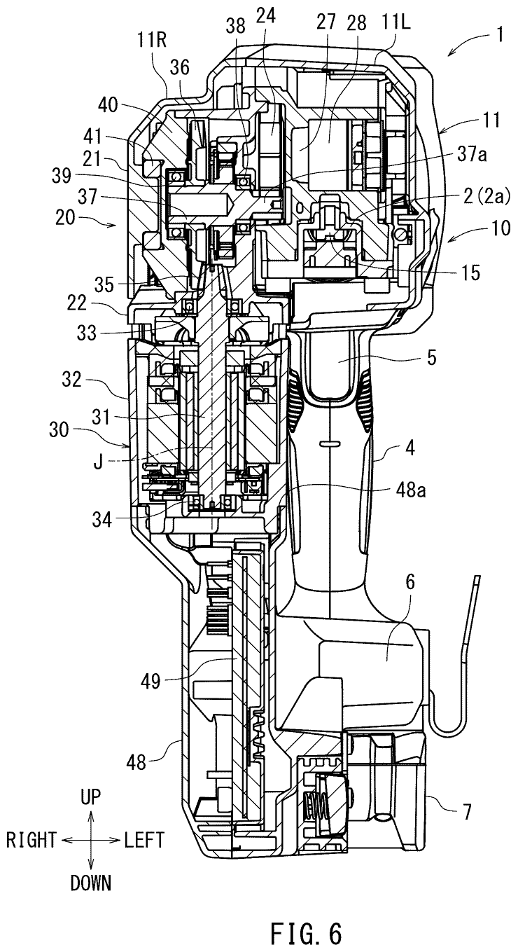

As shown in FIG. 1, a lower housing 48 is connected to the front portion of the battery attachment portion 6. The lower housing 48 extends forward. As shown in FIG. 6, a rectangular flat-shaped controller 49 is housed inside the lower housing 48. The controller 49 is supported in an upright orientation. The controller 49 mainly controls the operation of the electric motor 30. The lower housing 48 comprises an opening 48a at an upper portion of the lower housing 48. A lower portion of the electric motor 30 is held in the opening 48a of the lower housing 48.

Referring to FIGS. 1 and 6, the lift mechanism 20 is arranged in a region extending to the right and above the driving nose 2. The lift mechanism 20 has a function of returning the piston 13 and the driver 15 integrally in the rearward direction to the standby position after the driving operation is performed. When the piston 13 is moved rearward by the lift mechanism 20, the gas pressure in the accumulation chamber 14 increases.

As shown in FIG. 6, the lift mechanism 20 is housed in a lift housing 21 provided on the right side of the right half housing 11R. The lift housing 21 opens widely downward. The opening of the lift housing 21 is closed by a right lift base 22. An electric motor 30 is attached to the right lift base 22. An upper opening 48a of the lower housing 48 is located opposite the opening of the lift housing 21. The electric motor 30 is held between the opening of the lift housing 21 and the upper opening 48a of the lower housing 48.

The electric motor 30 is supported such that an axis of the output shaft 31 (motor axis J) extends in the up-down direction. Accordingly, the motor axis J is perpendicular to the driving direction (the direction perpendicular to the paper surface in FIG. 6). The electric motor 30 is activated by pulling the trigger 5, using power of the battery pack 7 as a power source. The magazine 50 is located along the left side of the electric motor 30.

As shown in FIG. 6, an output shaft 31 of the electric motor 30 is rotatably supported on the motor housing 32 via bearings 33 and 34. A driving bevel gear 35 is provided on the upper side of the output shaft 31. The driving bevel gear 35 engages a large-diameter driven bevel gear 36. The driven bevel gear 36 is supported by an intermediate shaft 37. The intermediate shaft 37 is rotatably supported around its axis via bearings 38 and 39. A rotation axis of the intermediate shaft 37 is perpendicular to both the motor axis J and the driving direction.

As shown in FIG. 6, the left bearing 38 is attached to the right lift base 22. The right bearing 39 is attached to a circular plate-shaped cover 40 that is attached to block the opening of the right lift base 22. A ring-shaped elastic member 41 is placed between the cover 40 and the lift housing 21. The vibration of the lift mechanism 20 is absorbed by the elastic member 41.

As shown in FIG. 6, a secondary gear 37a is provided on the left side of the intermediate shaft 37. The secondary gear 37a engages a main gear 24. The lifter shaft 27 is connected to the main gear 24. A wheel 28 is supported on the lifter shaft 27. When the electric motor 30 is activated, the wheel 28 rotates. A plurality of engaging portions are arranged around the circumference of the wheel 28. When the wheel 28 rotates, each engaging portion sequentially engages a corresponding rack tooth. Because of this movement, the driver 15 returns rearward from the forward end position to the standby position.

When the driver 15 is further rotates and the driver 15 moves rearward from the standby position, the engaging portion is disengaged from the rack tooth. As a result, the driver 15 moves forward in the driving direction owing to the gas pressure in the accumulation chamber 14 acting on the rear surface of the piston 13. The driving member n supplied into the driving passage 2a is driven by the driver 15 as it moves forward and driven into the workpiece W.

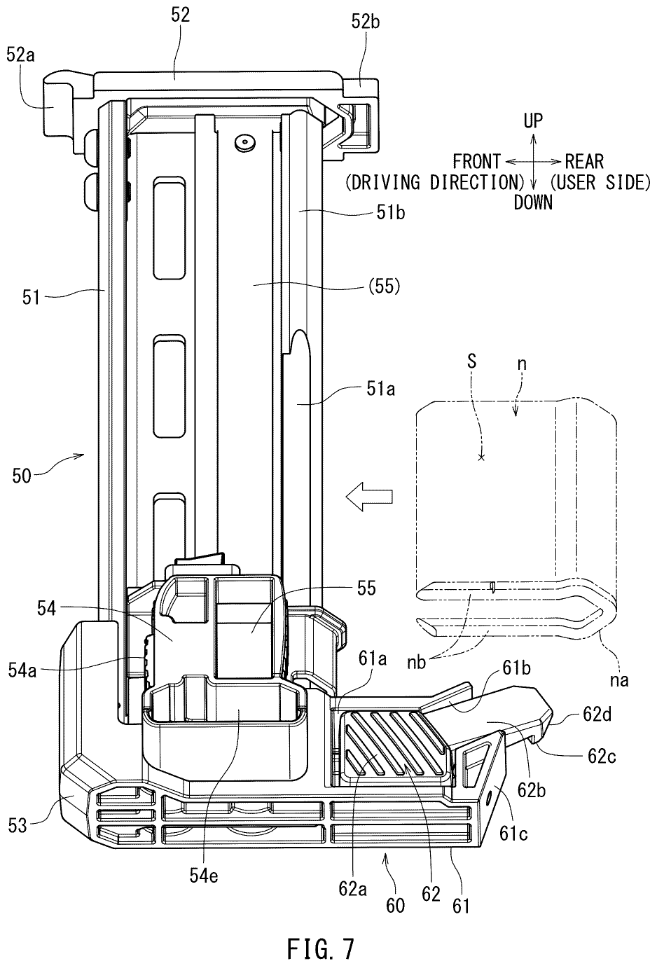

The magazine 50 can be attached to and detached from the tool main body 10. As shown in FIGS. 7, 8, and 9, the magazine 50 has a base 51 with a rectangular flat plate shape that extends in the up-down direction. An upper base 52 is mounted on the upper portion (first end) of the base 51, and a lower base 53 is mounted on the lower portion (second end) of the base 51. A pusher 54 is supported on the base 51 so as to be movable between the upper base 52 and the lower base 53. The pusher 54 is biased in a feed direction (upward) of the driving member n by a coil spring 55. The driving members n loaded in the base 51 is pushed toward the driving passage 2a by the pusher 54.

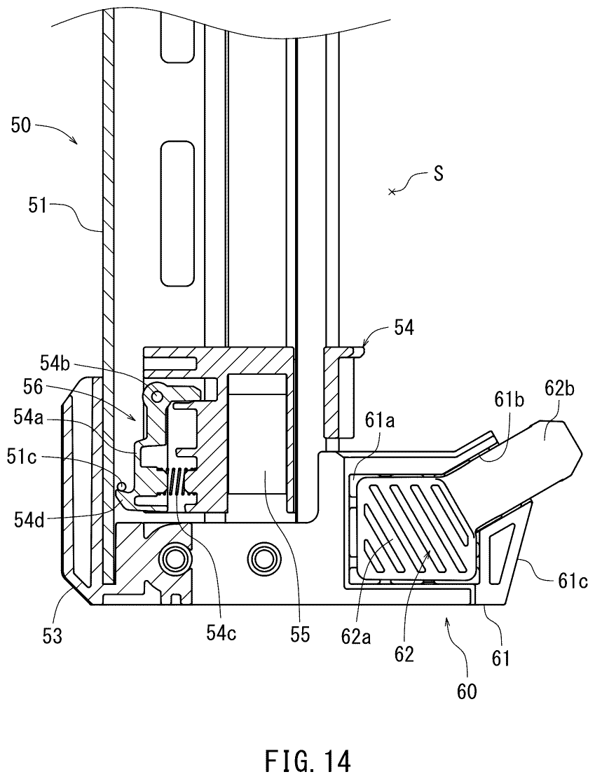

The pusher 54 can be moved to a retracted end position in the downward direction against the coil spring 55. The driving members n can be loaded when the pusher 54 is moved to the retracted end position. As shown in FIG. 14, the pusher 54 is provided with a position retention mechanism 56 for retaining the pusher 54 in the retracted end position relative to the base 51. A release lever 54a is provided on the front surface of the pusher 54. The release lever 54a is supported so as to be rotatable in the front-rear direction via a support shaft 54b. The release lever 54a is biased toward forward rotation by a compression spring 54c.

As shown in FIG. 14, an engaging portion 54d is provided on the front surface of the lower side of the release lever 54a. The engaging portion 54d protrudes forward. An engaged portion 51c is provided on a front portion of the lower side of the base 51. When the engaging portion 54d engages the engaged portion 51 from below, the pusher 54 is held in a retracted end position. When the release lever 54a is pushed rearward against the compression spring 54c, the engaging portion 54d moves rearward relative to the engaged portion 51c. Because of this movement, the position retention mechanism 56 is released, allowing the pusher 54 to move upward.

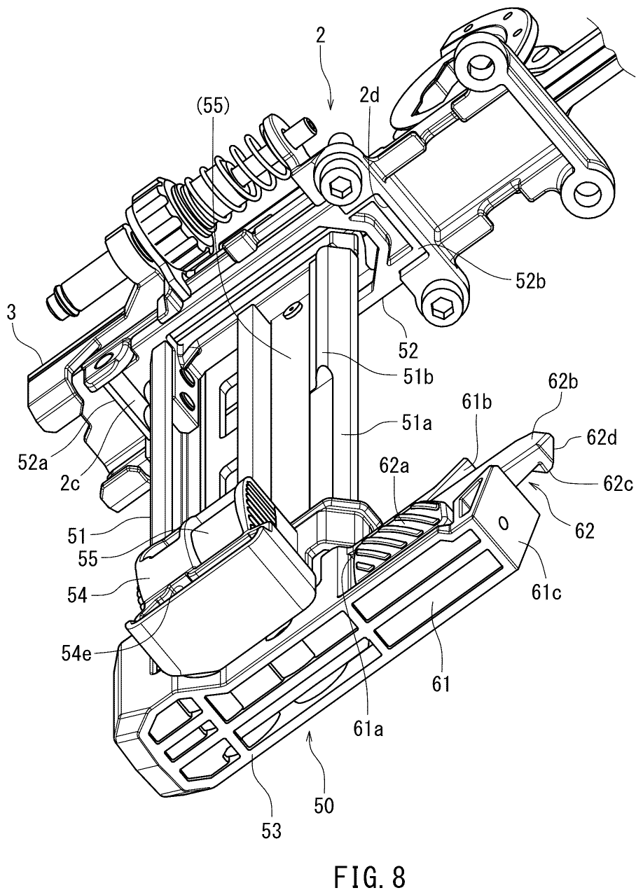

As shown in FIGS. 7 and 8, a box-shaped recess 54e is provided at the bottom of the pusher 54. The recess 54e opens toward the left and is surrounded by walls on the front, rear, top, bottom, and right sides. The user can press the release lever 54a with one finger while hooking another finger into the recess 54e. Accordingly, the user can both push the release lever 54 and slide the pusher 54 in the up-down direction with one hand.

As shown in FIG. 14, the lower surface of the engaging portion 54d of the pusher 54 is formed with an inclined surface that slopes rearwardly downward. Because of this configuration, when the pusher 54 is moved downward, the engaging portion 54d is pressed against the engaged portion 51c and displaced rearwardly relative to the engaged portion 51c by rotation of the release lever 54a. As a result, the engaging portion 54d automatically (passively) engages the engaged portion 51c from below. Therefore, when the pusher 54 is moved downward to the retracted end position, the pusher 54 is automatically (passively) locked at the retracted end position by hooking a finger into the recess 54e and pushing the pusher 54 downward.

As shown in FIGS. 7 and 8, a loading section 51a for loading a plurality of driving members n is provided at the rear of the base 51. The loading section 51a is provided in approximately half of the lower region of the base 51. As clearly shown in FIG. 8, the thickness of the base 51 is reduced in the loading section 51a. The driving member n is a so-called U-shaped tacker having a head na and two legs nb extending from both sides of the head na. The driving members n, temporarily coupled together, are loaded into the base 51 from the loading section 51a. The driving members n are loaded into the base 51, which is positioned between the two legs nb.

Referring to FIG. 7, a projection 51b is provided at the rear of the base 51 and above the loading section 51a. The projection 51b extends from the upper portion of the loading section 51a toward the driving passage 2a in the up-down direction. The position of the loaded driving member n in the front-rear direction is maintained by the projection 51b located inside the head na.

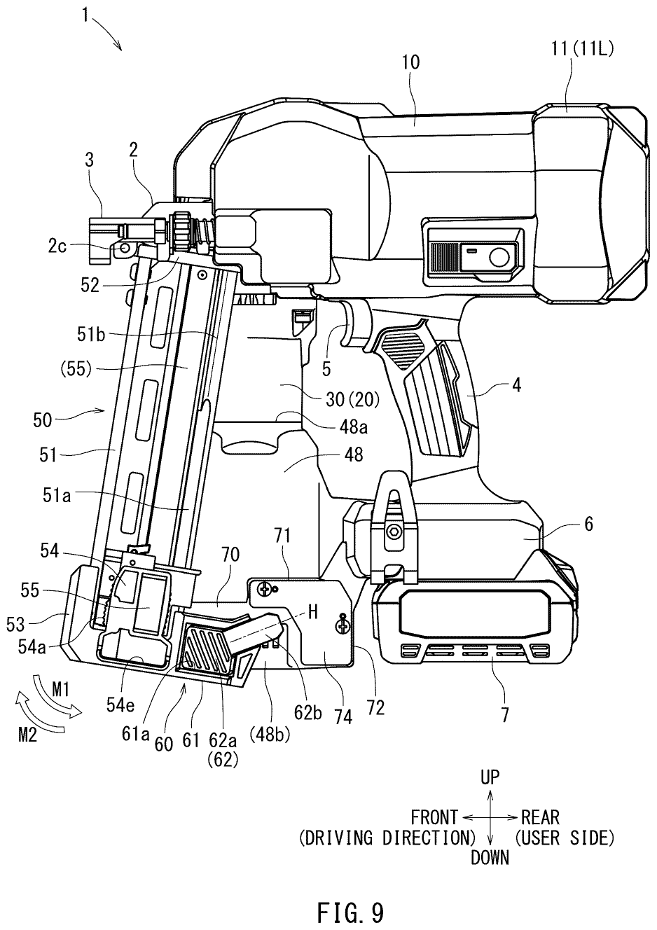

As shown in FIGS. 7 and 8, an engaging portion 52a is provided at the front of the upper base 52. As shown in FIGS. 8 and 9, a coupling shaft 2c is provided at the front of the driving nose 2. By engaging the engaging portion 52a with the coupling shaft 2c, the front of the upper base 52 is positioned relative to the driving nose 2. A protrusion 52b is provided at the rear of the upper base 52, extending rearward. A rectangular coupling recess 2d is formed at the rear of the driving nose 2. By fitting the protrusion 52b into the coupling recess 2d from below, the rear of the upper base 52 is positioned relative to the driving nose 2 in the upward, rearward, leftward and rightward directions. By positioning the upper base 52 on the lower surface side of the driving nose 2, the upper portion of the base 51 is positioned along the driving passage 2a. Because of this configuration, the driving members n can be smoothly supplied from the magazine 50 to the driving passage 2a.

As shown in FIG. 9, the magazine 50 can be attached to and detached from the tool main body 10 by rotating the magazine 50 in the front-rear direction (in the direction indicated by an arrow M1 and M2 in FIG. 9) with the engaging portion 52a hooked onto the coupling shaft 2c from above.

The magazine 50 is locked in place on the tool main body 10 by a locking portion 60 provided on the lower base 53. As shown in FIGS. 7 and 8, a rectangular flat base portion 61 is provided at the rear of the lower base 53. A rectangular retaining recess 61a opening leftward is provided in the base portion 61. A locking member 62 is retained in the retaining recess 61a. A guiding recess 61b is provided at the upper corner of the rear side of the retaining recess 61a. The guiding recess 61b extends obliquely upward toward the rear.

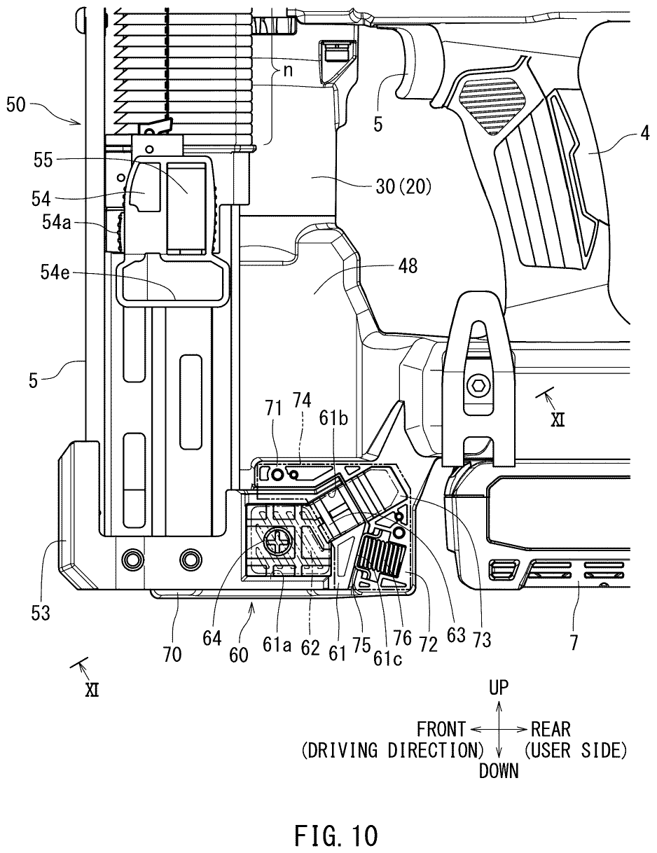

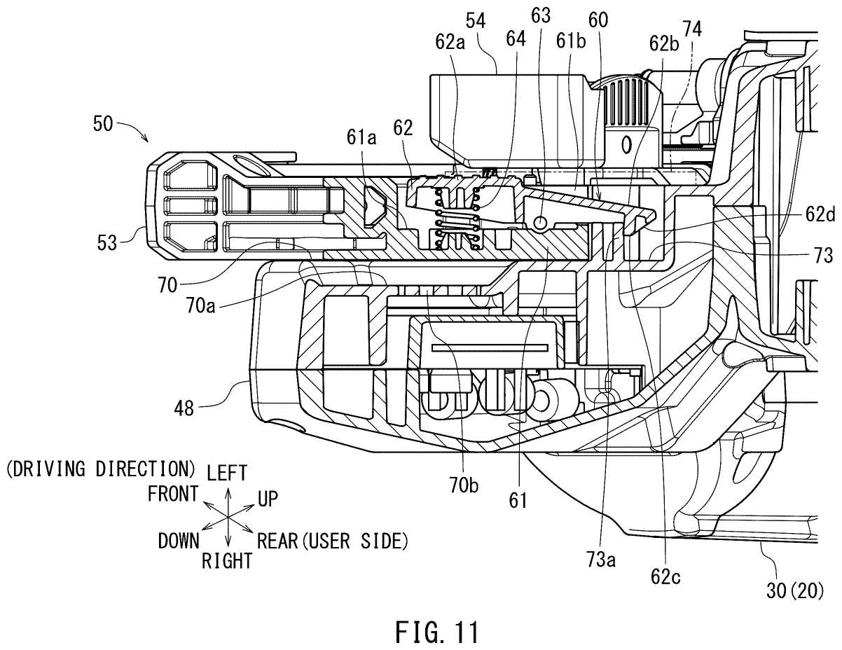

As shown in FIGS. 10 and 11, a shaft 63 is provided in the guiding recess 61b of the base portion 61. The locking member 62 is supported so as to be tiltable in the left-right direction (in the thickness direction of the locking member 62) around the shaft 63. Referring to FIGS. 7 and 8, the locking member 62 has a rectangular flat plate-shaped actuator 62a and a lever 62b that extends obliquely upward toward the rear from an upper corner of the rear side of the actuator 62a. The actuator 62a is located in the retaining recess 61a, and the lever 62b is located in the guiding recess 61b. A rear (tip end) portion of the lever 62b protrudes further rearward beyond the guiding recess 61b.

An elastic member 64 is placed between the bottom of the retaining recess 61a and the actuator 62a. In this embodiment, a compression spring is used as the elastic member 64. The locking member 62 is biased in a direction to displace the actuator 62a to the left (locking side) and to displace the tip end portion of the lever 62b to the right by the biasing force of the elastic member 64. As shown in FIGS. 7 and 8, a locking claw 62c and an inclined guide surface 62d are provided at the tip end of the right side of the lever 62b. The inclined guide surface 62d is inclined in an insertion direction of the lever 62b (in the left-right direction).

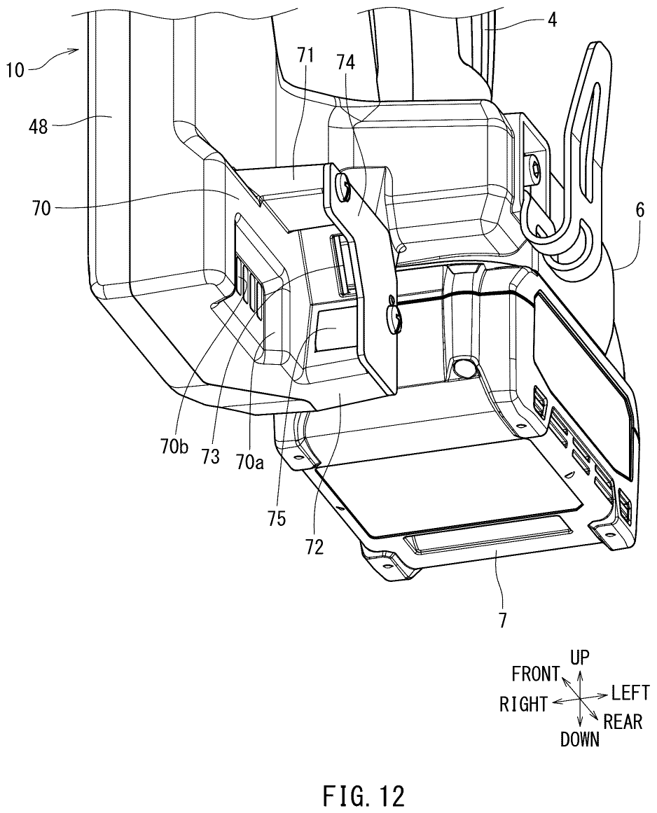

As shown in FIGS. 7 and 12, a lock receptacle 70 is provided on the left side of the lower housing 48 of the tool main body 10. FIG. 12 shows a rectangular recess 70a in the lock receptacle 70. A ventilation hole 70b is arranged at the bottom of the recess 70a. Cooling air for cooling, for example, the controller 49 and the electric motor 30 is introduced through the ventilation hole 70b.

As shown in FIG. 12, two walls 71 and 72, i.e. an upper wall 71 and a lower wall 72, are integrally formed on the rear side of the lock receptacle 70, extending leftward from the left side of the lower housing 48.

As shown in FIG. 12, the upper wall 71 extends in the front-rear direction. The lower wall 72 extends downward from the rear of the upper wall 71. A front surface of the lower wall 72 extends obliquely upward toward the front. A locking recess 73 is located where the upper wall 71 intersects with the lower wall 72. The locking recess 73 extends obliquely upward toward the rear with a constant width.

As shown in FIG. 11, a claw engagement portion 73a is provided at the bottom of the locking recess 73. The locking claw 62c of the locking member 62 is engageable with the claw engagement portion 73a. When the locking member 62 is displaced toward the locking side by the elastic member 64, the locking claw 62c engages the claw engagement portion 73a, and the locking member 62 is held in the locking position.

Referring to FIG. 11, when the actuator 62a is pushed to the right against the force of the elastic member 64, the locking member 62 tilts toward the unlocked side around the shaft 63. As a result, the locking claw 62c of the locking member 62 disengages from the claw engagement portion 73a. This embodiment further referred in FIGS. 1 and 10 shows the operating direction for locking and unlocking the actuator 62a is a direction (left-right direction) that intersects both the feed direction of the driving members n in the magazine 50 and the driving direction of the driving member n at the driving nose 2. For this reason, the user can perform a pressing operation of the actuator 62a by pinching it from both sides with the fingertips of the left hand, for example.

As shown in FIG. 12, a cover 74 is attached along the left side of the upper wall 71 and the lower wall 72. The rear side of the lock receptacle 70 and the locking recess 73 are blocked by the cover 74. When the magazine 50 is attached to or detached from the tool main body 10, the position of the lever 62b of the locking member 62 in the left-right direction is guided by the claw engagement portions 73a of the locking recess 73 and the cover 74.

When the magazine 50 is attached to the tool main body 10, the lock receptacle 70 and the cover 74 function as guide portions for guiding the magazine 50 in the thickness direction. When the magazine 50 is attached, the base portion 61 of the magazine 50 is inserted between the lock receptacle 70 and the cover 74. The lock receptacle 70 and the cover 74 guide the lower portion of the magazine 50 in the left-right direction (thickness direction of the magazine 50), preventing the lower portion of the magazine 50 from rattling in the left-right direction. In addition, in the locked state, a force in the leftward direction (unlocking direction) is applied to the lever 62b as a reaction force against the biasing force of the elastic member 64 from the claw engagement portion 73a (locking recess 73). The leftward force (reaction force of the elastic member 64) applied to lever 62b is received by the cover 74. As a result, a displacement of the lever 62b in a direction in which the lever 62b disengaged from the claw engagement portion 73a can be prevented, and the magazine 50 can be firmly locked to the tool main body 10.

As shown in FIGS. 10 and 12, a play suppression member 75 is provided on the front surface of the lower wall 72. The play suppression member 75 is supported so as to be displaceable between a position protruding from the front surface of the wall 72 and a position flush with the front surface of the wall 72. The play suppression member 75 is biased in a direction protruding from the front surface of the wall 72 by an elastic member, such as a compression spring 76.

Referring to FIG. 9, when the magazine 50 is attached to the tool main body 10, the magazine 50 is rotated in a counterclockwise direction in FIG. 9 (in the direction indicated by an arrow M1 in FIG. 9) around the coupling shaft 2c, with the engaging portion 52a engaging the coupling shaft 2c of the driving nose 2. The lever 62b of the locking member 62 protrudes in a tangential direction H along the circumference centered on the coupling shaft 2c (engaging portion 52a). The locking recess 73 also extends in the same direction. Therefore, when the magazine 50 is rotated rearward around the coupling shaft 2c, the lever 62b of the locking member 62 is precisely aligned and directly inserted into the locking recess 73.

As shown in FIG. 11, the lever 62b is biased toward the bottom of the locking recess 73 by the elastic member 64. Accordingly, when the lever 62b is inserted into the locking recess 73, the inclined guide surface 62d of the lever 62b contacts and moves over the claw engagement portion 73a, thereby automatically (passively) engaging the locking claw 62c with the claw engagement portion 73a. Because of this configuration, when the magazine 50 is attached to the tool main body 10, the magazine 50 is automatically (passively) locked in the attached state by inserting the lever 62b of the locking portion 60 into the locking recess 73 without pressing the actuator 62a. This improves the operability of attaching the magazine 50 to the tool main body 10.

As shown in FIG. 10, when the magazine 50 is attached to the tool main body 10, the play suppression member 75 on the side of the lock receptacle 70 is pressed by the rear surface 61c of the base portion 61 of the magazine 50. As a result, the biasing force of the compression spring 76 is applied to the base portion 61 of the magazine 50. In more detail, the biasing force of the compression spring 76 presses the rear surface of the base portion 61 obliquely upward toward the front. The biasing force of the compression spring 76 presses the magazine 50 toward the driving nose 2, thereby preventing the magazine 50 from rattling. As a result, the driving members n can be smoothly delivered from the magazine 50 to the driving passage 2a.

In addition, when the magazine 50 is installed, the play suppression member 75 is pressed by the rear surface 61c of the base portion 61. Accordingly, when the locking member 62 is released by pulling the actuator 62a, the lower portion of the magazine 50 is pushed in the removal direction by the biasing force of the compression spring 76 via the play suppression member 75. This improves the operability of magazine detachment from the tool main body 10.

Referring to FIG. 11, when the magazine 50 is detached from the tool main body 10, the actuator 62a of the locking member 62 is pushed rightward against the elastic member 64. By the pushing operation of the actuator 62a, the locking member 62 tilts toward the unlocking side around the shaft 63. When the locking member 62 tilts toward the unlocked side, the lever 62b tilts to the left. As a result, the locking claw 62c of the lever 62b disengages from the claw engagement portion 73a.

After the locking member 62 is unlocked by pushing the actuator 62a to the right, the magazine 50 can be detached from the tool main body 10 by rotating it clockwise in FIG. 9 around the coupling shaft 2c (in the direction indicated by the arrow M2). The magazine 50 can be detached from the tool main body 10 by, for example, displacing the lower portion of the magazine 50 forward with the actuator 62a pressed with a left hand. For this reason, the user can remove the magazine 50 with only the left hand while holding the grip 4 with the right hand.

As shown in FIG. 9, the magazine 50 can be attached to and detached from the tool main body 10 even while the pusher 54 of the magazine 50 is in the retracted end position. Furthermore, the user can unlock the locking member 62 regardless of the position of the pusher 54.

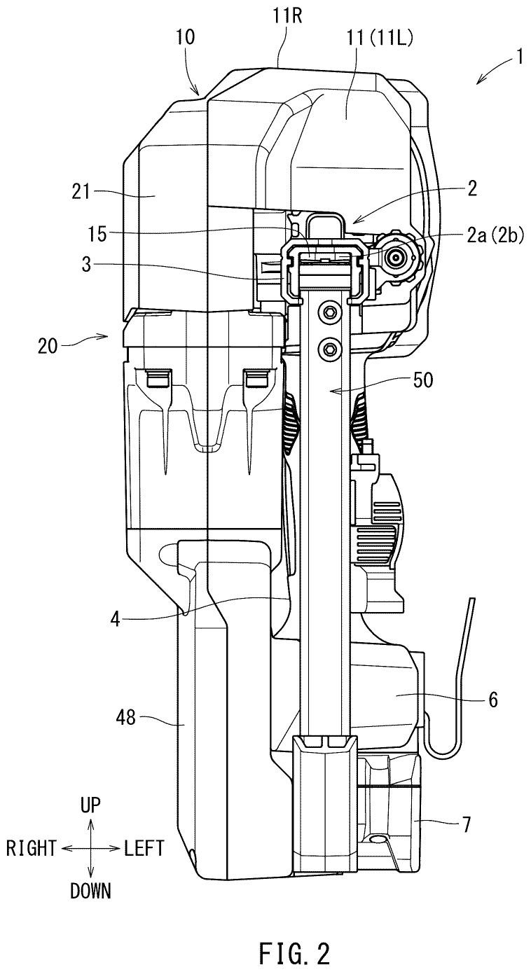

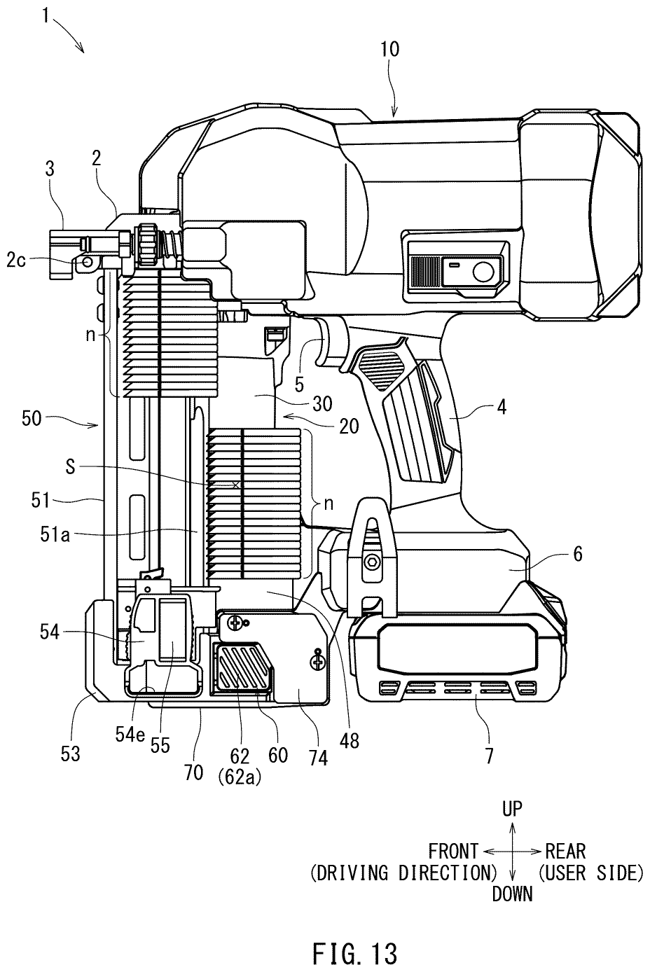

As shown in FIG. 13, the driving member n can be loaded into the magazine 50 while the magazine 50 is attached to the tool main body 10. A loading area S is provided behind the loading section 51a for a plurality of driving members n to be loaded when the magazine 50 is attached. The magazine 50 is mounted so as to extend downward from the driving nose 2. As shown in FIG. 2, the lift mechanism 20 is positioned offset to the right relative to the driving nose 2. Because of this configuration, a loading area S for the driving members n is provided to the left of the lift mechanism 20. The driving members n are loaded in a posture with the legs nb facing forward, passing through the loading section 51a and extending across the base 51. The driving members n can be loaded through the loading section 51a while the pusher 54 is held downward in the retracted end position. After the driving members n are loaded into the base 51, the position retention mechanism 56 of the pusher 54 is released (the release lever 54a is unlocked) such that the loaded driving member n are pushed toward the driving nose 2.

According to the embodiment, the driving tool 1 is provided with the locking member 62 for attaching the magazine 50 to the tool main body 10. The driving tool 1 has the actuator 62a that is operated when the magazine 50 is detached from the tool main body 10 to move the locking member 62 from the locking position to the unlocking position. The actuator 62a can be operated in a direction that intersects both the feed direction of the driving members n in the magazine 50 and the driving direction of the driving members n.

Therefore, by operating the actuator 62a in the operating direction, the locking member 62 is moved from the locking position to the unlocking position, thereby removing the magazine 50 from the tool main body 10. Thus, the operability of detaching the magazine 50 from the tool main body 10 can be improved.

The operating direction of the actuator 62a is at an intersection between the feed direction of the driving members n in the magazine 50 and the driving direction of the driving member n at the driving nose 2. Accordingly, the operating direction is generally in the left-right direction as viewed from the user holding the driving tool 1. Therefore, the user can hold the grip 4 of the driving tool 1 with a right hand, for example, and the magazine 50 with a left hand while operating the actuator 62a to move the magazine 50 forward (in the direction indicated by the arrow M2 in FIG. 9) to detach it from the tool main body 10. The magazine 50 can be detached from the tool main body 10 while being held in the hand during work, etc., without the trouble of temporarily placing the driving tool 1 on a workbench. As a result, the operability of detaching the magazine 50 from the tool main body 10 can be improved.

According to the embodiment, the elastic member 64 is provided for biasing the locking member 62 from the unlocking position to the locking position. By operation of the actuator 62a, the locking member 62 moves from the locking position to the unlocking position against the biasing force of the elastic member 64. Accordingly, the locking member 62 is biased to the locking position by the biasing force of the elastic member 64. The actuator 62a is pushed rightward against the biasing force of the elastic member 64.

According to the embodiment, the cover 74 and the lock receptacle 70 are provided in the tool main body 10 as guide portions for guiding the magazine 50 in the thickness direction (left-right direction) of the magazine 50 when the magazine 50 is attached to the tool main body 10. After being guided by the guide portions, the magazine 50 is locked in the locking position by the locking member 62. Accordingly, the magazine 50 can be more easily attached to the magazine 50.

According to the embodiment, the compression spring 76 together serves as the play suppression member 75 by biasing the magazine 50 toward the tool main body 10, thereby preventing any gap between the magazine 50 and the tool main body 10. Therefore, rattling of the magazine 50 is prevented when it is attached to the tool main body 10.

According to the embodiment, the cover 74 is provided to cover the compression spring 76 as the play suppression member, and the cover 74 also serves as a guide portion for guiding the magazine 50 when the magazine 50 is attached to the tool main body 10. Therefore, the effectiveness of the cover 74 is improved. In addition, a number of parts can be reduced compared to a case where the function of covering the compression spring 76 and the function of guiding the magazine 50 are achieved by separate members.

According to the embodiment, the cover 74 covers the surface of the tool main body 10 and guides the magazine 50 in cooperation with the surface of the tool main body 10. Accordingly, the cover 74 covering the compression spring 76 also functions as a guide portion for guiding the magazine 50. This makes it possible to maintain the compactness of the tool main body 10 and avoid an increase in the number of components.

According to the embodiment, the compression spring 76 together serving as the play suppression member 75 biases the magazine 50 in the driving direction and the feed direction. Accordingly, the rattling of the magazine 50 is prevented in both the driving direction and the feed direction.

According to the embodiment, the driving members n can be loaded into the magazine 50 from the loading area S which is positioned opposite to the driving direction of the driving members n. The actuator 62a of the locking member 62 is provided on the rear end side of the feed direction of the driving members n in the magazine 50. with respect to the loading area S. Accordingly, the actuator 62a of the locking member 62 can be positioned without compromising (sacrificing) the loading area S.

According to the embodiment, the magazine 50 has the pusher 54 that pushes the driving members n in the feed direction. The actuator 62a is exposed so as to be operated when the pusher 54 is located at the retracted end position in the feed direction. Accordingly, the actuator 62a can be operated even when the pusher 54 is located at the retracted end position.

According to the embodiment, the tool main body 10 has the coupling shaft 2c, which is an engaging portion for rotatably engaging the upper portion of the magazine 50, defined as its first end. The magazine 50 has the locking member 62 that protrudes from the second end opposite the first end in a tangential direction H along the circumference centered on the coupling shaft 2c. As a result, the locking member 62 engages the tool main body 10 with greater reliability, contributing to a stable locking condition of the magazine 50.

Various changes can be made to the above-described embodiment. In the embodiment, U-shaped staples are loaded into the magazine 50 as the driving members n. Instead, the illustrated locking member 60 may be applied to a magazine that holds rod-shaped nails.

In the above-described embodiment, a compression spring is illustrated as an example of the elastic member 64 that biases the locking member 62 toward the locking position. Instead, a leaf spring may be used.

In the above-described embodiment, the magazine 50 is arranged on the left side of the lift mechanism 20 and the lift mechanism 20 is arranged offset to the right relative to the driving nose 2. Therefore, the locking member 62 is unlocked by pushing the actuator 62a of the locking member 62 toward the right. Instead, the magazine 50 may be arranged on the right side of the lift mechanism 20 and the lift mechanism 20 is arranged offset to the left relative to the driving nose 2, for use on the other side. In this case, the locking member 62 may be unlocked by pushing the actuator 62a of the locking member 62 toward the left.

In the above-described embodiment, a gas spring-type driving tool is illustrated as the driving tool 1. Instead, the lock portion 60 of the magazine 50 may be applied to a compressed air-type driving tool driven by compressed air supplied from outside, a mechanical spring-type driving tool that uses a thrust force of a compression spring as the driving force, or an electric wheel-type driving tool.

We claim:

1. A driving tool comprising:
a tool main body configured to drive a driving member in a driving direction;
a magazine configured to be detachably secured to the tool main body to supply the driving member to the tool main body;
a locking member arranged on the magazine and configured to secure the magazine to the tool main body;
an actuator arranged on the magazine and configured to move the locking member from a locking position to an unlocking position to detach the magazine from the tool main body,
wherein the actuator is configured to move in a direction that intersects a feed direction of the driving member within the magazine and the driving direction of the driving member.

2. The driving tool according to claim 1, further comprising a first elastic member that biases the locking member from the unlocking position to the locking position,
wherein the locking member is configured to move from the locking position to the unlocking position against a biasing force of the elastic member upon operation of the actuator.

3. The driving tool according to claim 1, further comprising a guide portion located on the tool main body and configured to guide the magazine in a thickness direction of the magazine when the magazine is being secured to the tool main body,
wherein the magazine is locked in the locking position by the locking member upon being guided by the guide portion.

4. The driving tool according to claim 1, further comprising a play suppression member that biases the magazine toward the tool main body to prevent a gap between the magazine and the tool main body.

5. The driving tool according to claim 4, further comprising a cover that encloses the play suppression member,
wherein the cover serves as the guide portion that guides the magazine when the magazine is secured to the tool main body.

6. The driving tool according to claim 5, wherein the cover encloses a portion of a tool main body surface, and wherein the cover is configured to guide the magazine in cooperation with the portion of the tool main body surface.

7. The driving tool according to claim 4, wherein the play suppression member biases the magazine in the driving direction and the feed direction.

8. The driving tool according to claim 1, wherein,
the magazine being secured to the tool main body forms a loading area positioned opposite to the driving direction of the driving member for loading the driving member into the magazine, and
the actuator is located on a rear end side of the feed direction of the driving member inside the magazine.

9. The driving tool according to claim 1, further comprising a pusher that is movably arranged inside the magazine to push the driving member in the feed direction,
wherein the actuator is operable when the pusher is moved to a retracted end position in the feed direction.

10. The driving tool according to claim 1, further comprising a coupling shaft that rotatably engages an engaging portion positioned at a first end of the magazine,
wherein the locking member protrudes from a second end of the magazine opposite to the first end in a tangential direction along a circumference centered on the coupling shaft.

11. The driving tool according to claim 4, wherein the play suppression member includes a second elastic member.

12. The driving tool according to claim 11, wherein the second elastic member biases the magazine in a removal direction of the magazine by a biasing force of the second elastic member when the magazine is detached from the tool main body.

13. The driving tool according to claim 3, wherein,
the actuator is integrally formed with the locking member,
the locking member includes a lever extending from the actuator and a shaft, and
the actuator is biased by the first elastic member for tilting the lever around the shaft to move the locking member to the locking position.

14. The driving tool according to claim 13, further comprising a locking recess located on a side of the tool main body, wherein the locking recess has a claw engagement portion,
wherein the claw engagement portion is configured to engage a locking claw for locking the magazine onto the tool main body, and wherein the locking claw is formed at a tip end of the lever.

15. The driving tool according to claim 14, wherein,
the lever includes an inclined guide surface at the tip end of the lever, and
the inclined guide surface contacts and moves over the claw engagement portion to engage the locking claw with the claw engagement portion.

16. The driving tool according to claim 14, further comprising a lock receptacle, a first wall, and a second wall, all disposed on a lower housing of the tool main body and configured for holding the magazine, wherein the first wall extends laterally from the lock receptacle, and the second wall extending downward from the first wall,
wherein the locking recess is formed at an intersection of the first wall and the second wall.

17. The driving tool according to claim 16, further comprising a cover that is attached between the first wall and the second wall,
wherein the guide portion includes the lock receptacle and the cover.

18. The driving tool according to claim 17, further comprising a main body housing in the tool main body, the main body housing including a left half housing and a right half housing,
wherein the lock receptacle and the cover are provided at a lower portion of either the left or right half housing to which the magazine is secured.

19. A driving tool comprising:
a tool main body configured to drive a driving member in a driving direction;
a magazine configured to be detachably secured to the tool main body to supply the driving member to the tool main body;
a locking member arranged on the magazine and configured to secure the magazine to the tool main body;
an actuator integrally formed with the locking member and configured to move the locking member from a locking position to an unlocking position to detach the magazine from the tool main body; and
a coupling shaft that rotatably engages an engaging portion positioned at a first end of the magazine, wherein,
the actuator is configured to move in a direction that intersects a feed direction of the driving member within the magazine and the driving direction of the driving member,
the locking member protrudes from a second end of the magazine opposite to the first end in a tangential direction along a circumference centered on the coupling shaft, and
the locking member is configured to be movable in the tangential direction for locking the magazine onto the tool main body.

20. The driving tool according to claim 19, further comprising an elastic member that biases the locking member from the unlocking position to the locking position,
wherein the locking member is configured to move from the locking position to the unlocking position against a biasing force of the elastic member upon operation of the actuator.
